(19) United States
(12) Patent Application Publication
(10) Pub. No.: US 2013/0275547 A1
(43) Pub. Date: Oct. 17, 2013

(54) SYSTEM AND METHOD FOR PROVIDING SUPPLEMENTAL ELECTRONIC CONTENT TO A NETWORKED DEVICE

(71) Applicants: Daniel Boon Ling Chew, Santa Clara, CA (US); Roderick William Macdonald, Kanata (CA); Russell Offen, Gloucester (CA); Richard Kenneth Algernon Chin, San Jose, CA (US)

(72) Inventors: Daniel Boon Ling Chew, Santa Clara, CA (US); Roderick William Macdonald, Kanata (CA); Russell Offen, Gloucester (CA); Richard Kenneth Algernon Chin, San Jose, CA (US)

(73) Assignee: KINDSIGHT INC., Sunnyvale, CA (US)

(21) Appl. No.: 13/448,164

(22) Filed: Apr. 16, 2012

(51) Int. Cl. G06F 15/16

(52) U.S. Cl. 709/217

(57) ABSTRACT

Providing tailored supplemental content to a user in a Network Address Translation (NAT) environment is described. Network traffic from a user to a supplemental content provider is monitored within a first network and a supplemental content identifier (ID) is identified in the monitored traffic and linked to a profile of the device or user of the device. A supplemental content provider on a second network receives a request for supplemental content that includes the supplemental content ID and uses the received supplemental content ID to retrieve the profile linked to the supplemental content ID. Supplemental content may then be generated or retrieved based on the retrieved profile and returned to the user device.

### TECHNICAL FIELD

The current description relates to electronic content delivery, and in particular to tailoring electronic content to a user of a computing device based on monitored network traffic.

### BACKGROUND

A network address is associated with a computing device connected to a network allowing content to be delivered to the device. The network address is utilized to uniquely identify the device to enable content access to and from the device. The content may be, for example, a web page, application, data file, or other content. Although a device may be assigned a unique network address, the address may be only unique within a local network and not directly addressable in the larger network and will therefore need to be translated to an address addressable in the larger network. The network address of the device may therefore be presented to a content source by an address associated with a proxy or gateway between different networks, such as a router. The assigned IP address may be from a private address range within a local area network associated with the route, where as router may in turn be part of a larger network such as a corporate network, or an Internet Service Provider (ISP) network, and may be assigned its own IP address on the larger network. The router may modify traffic to and from connected devices using network address translation (NAT) in order to translate one or more of the IP address of the router's IP address space to the IP address range of the larger network. In turn, the larger network may be connected to one or more other networks, for example the Internet, and may modify addresses in the larger network space to another network space using NAT.

The use of NAT makes it difficult for a server located outside the address space of the device to uniquely identify the device requesting content. As such, providing supplemental content that is tailored to the device, and in particular tailored to a user of a device can be difficult. One solution to providing tailored supplemental content in a NAT environment is to associate a user identifier with the profile; however, in order to do so a user may be required to login to an account in order to be able to identify the user ID. The user ID may be passed to the supplemental content provider and used to retrieve a profile associated with the user ID. Additionally or alternatively, a unique user identifier associated with a profile could be stored on the user device in a cookie and passed to the supplemental content provider. Although tailored content may be provided to a user in a NAT environment if the user identifies themselves, or if the user has enabled cookies, not all users enable cookies, or wish to login or otherwise identify themselves.

It is desirable to be able to provide tailored supplemental content to a device when the device is in a different address space than the system providing the tailored supplemental content.

### BRIEF DESCRIPTION OF DRAWINGS

Further features and advantages of the present disclosure will become apparent from the following detailed description, taken in combination with the appended drawings, in which:

FIG. 1 depicts a system for delivering advertisements to a networked device;

FIG. 2 depicts a system for providing tailored content to a networked device;

FIG. 3 depicts a system for providing tailored content to a networked device in a different address space;

FIG. 4 depicts components of a system for providing tailored content to a networked device in a different address space;

FIG. 5 depicts a method of providing tailored content to a networked device in a different address space;

FIG. 6 depicts a process flow for providing tailored content to a networked device in a different address space; and

FIG. 7 depicts a further process flow for providing tailored content to a networked device in a different address space.

It will be noted that throughout the appended drawings, like features are identified by like reference numerals.

### DETAILED DESCRIPTION

In accordance with an aspect of the present disclosure there is provided a method for providing tailored supplemental content to a user, the method comprising: receiving, at a server, a supplemental content identifier (ID) identified from monitored network traffic from a user device traversing a first network, the network traffic from the user device associated with a first network address while traversing the first network which is translated to a second network address while traversing a second network; linking, at the server, a profile associated with the first network address to the identified supplemental content ID; receiving, at the server, a profile request from a supplemental content provider, the profile request comprising the supplemental content ID; and sending, from the server to the supplemental content provider, the profile linked to the supplemental content ID.

In accordance with another aspect of the present disclosure there is provided a device for providing a profile for use in providing tailored supplemental content to a user, the device comprising: an network interface for transmitting and receiving data over a network; a processor for executing instructions; and a memory storing instructions, the instructions when executed by the processor, configuring the device to provide a method comprising: receiving, over the network interface, a supplemental content identifier (ID) identified from monitored network traffic from a user device traversing a first network, the network traffic from the user device associated with a first network address while traversing the first network which is translated to a second network address while traversing a second network; linking a profile associated with the first network address to the identified supplemental content ID; receiving, over the network interface, a profile request from a supplemental content provider, the profile request comprising the supplemental content ID; and sending, over the network interface, to the supplemental content provider, the profile linked to the supplemental content ID.

In accordance with yet another aspect of the present disclosure there is provided a system for providing tailored supplemental content to a user, the system comprising: a network interface device (NID) adapted for monitoring traffic in a first network; a server adapted for: receiving from the NID a supplemental content identifier (ID) identified from the monitored network traffic from a user device traversing the first network, the network traffic from the user device associated with a first network address while traversing the first network which is translated to a second network address while traversing a second network the server; linking a profile associated with the first network address to the identified supplemental content ID; receiving a profile request from a supplemental content provider, the profile request comprising the supplemental content ID; and sending to the supplemental content provider, the profile linked to the supplemental content ID; and a supplemental content provider server adapted for: receiving a supplemental content request including the supplemental content ID; sending the profile request including the supplemental content ID from the supplemental content request; receiving, at the supplemental content provider, the profile linked to the supplemental content ID; retrieving, at the supplemental content provider, supplemental content based on the received profile; and sending the retrieved supplemental content from the supplemental content provider to the user device.

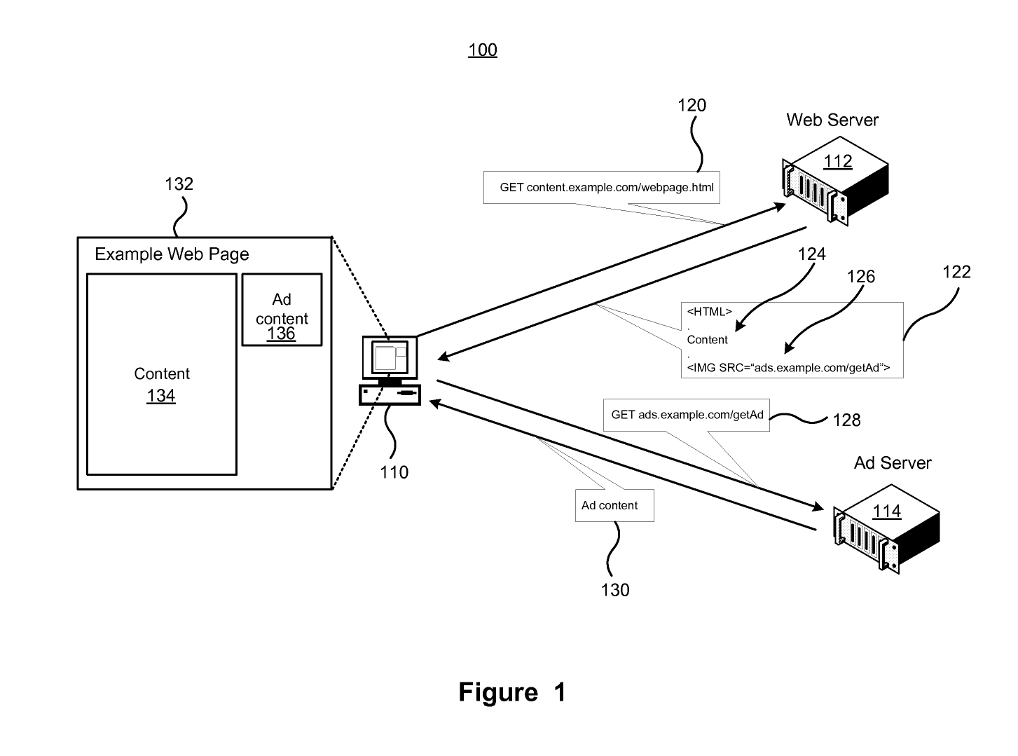

Embodiments are described below, by way of example only, with reference to FIGS. 1-7.

FIG. 1 depicts a system for delivering advertisements to a networked device. The system 100 is a simplified depiction for the clarity of the description. It will be appreciated that the implementations described herein can be extended to more complex implementations by one skilled in the art. As will be appreciated, a user device 110 may have a web browser executing on it that allows a user to request a web page from a web server 112. The user device 110 sends a request 120 to a web server 112 over one or more interconnected networks (not shown). The web page request 120 is depicted as a Hyper Text Transfer Protocol (HTTP) GET request, although other types of requests are possible. As depicted, the web page request includes a universal resource locator (URL) specifying the web page to be retrieved. In FIG. 1, the web page request is for ‘webpage.html’ which is located at a server identified as ‘content.example.com’. The web server 112 receives the request 120, retrieves the requested content and returns the requested content 122 to the user device 110.

The returned content is depicted as a simple web page comprising some content 124 and an ad tag 126 for advertisement content that will be requested. One skilled in the art will appreciate that the web page returned from the web server may include requests for content from various different servers. The ad tag 126 comprises an indication of a location to retrieve the advertisement content from. The advertisement content may include images, audio, video, animations, text, as well as script or code for providing functionality to the ad, such as interactivity. For the ad may include script or code for providing functionality to the ad such as the tracking of whether a user has clicked on the advertisement.

When the user device 110 receives the web page 122 it requests the ad from the ad server in accordance with the ad tag. As depicted, the ad request 128 comprises an HTTP GET request for an ad, in particular an ad from ‘ads.example.com/getAd’, which could be a web service that returns ads. It is noted that although both the ad server and the web server are described as being located at example.com, the two servers do not need to be from the same domain. The ad server 114 receives the ad request 128 and retrieves or generates an ad and returns the ad 130, which is depicted as being an image in the web page for simplicity, to the user device 110. The user device 110 displays the web page 132, including the content 134 and the ad 136. It will be appreciated that the returned ad may include additional content other than a simple static image, for example, the ad may include an indication of a web page to display if the user clicks on the ad.

The general process for displaying an ad on a web page has been described with reference to FIG. 1. It will be appreciated that the process of displaying an advertisement may be more complex and involve various different servers in order to allow easier management of ad inventory, ad purchasing, monitoring and other features. Further, although the web page content and the advertisement are depicted as being provided by the web server and the ad server, it is possible that the content and ads be provided by one or more other servers, for example by a content delivery network (CDN). Further, although described with regards to providing an advertisement for a web page, it is possible to provide an advertisement or other supplementary content for a web page or more generally, requested content. The system of FIG. 1 does not tailor the ad provided to the user device. As described further below, it is possible to tailor the ad returned to the user device 110 based on a profile associated with the user device, or a user of the user device. The profile associated with the user device, or the user of the user device, may be any information that pertains or relates to a user that may be used in providing tailored content. For example, a profile may provide a plurality of key-value pairs indicating an estimate of a user's interest in various information categories. Additionally alternatively, the profile could be information that provides a grouping of the user into a plurality of demographic categories, such as estimated age and estimated profession. The profile is generated by analyzing user data traffic and associating interests with the traffic. It is contemplated that the particular structure of a profile may vary depending on various factors, including overall system design, available information for use in generating the profile, desired granularity of the profile as well as other factors.

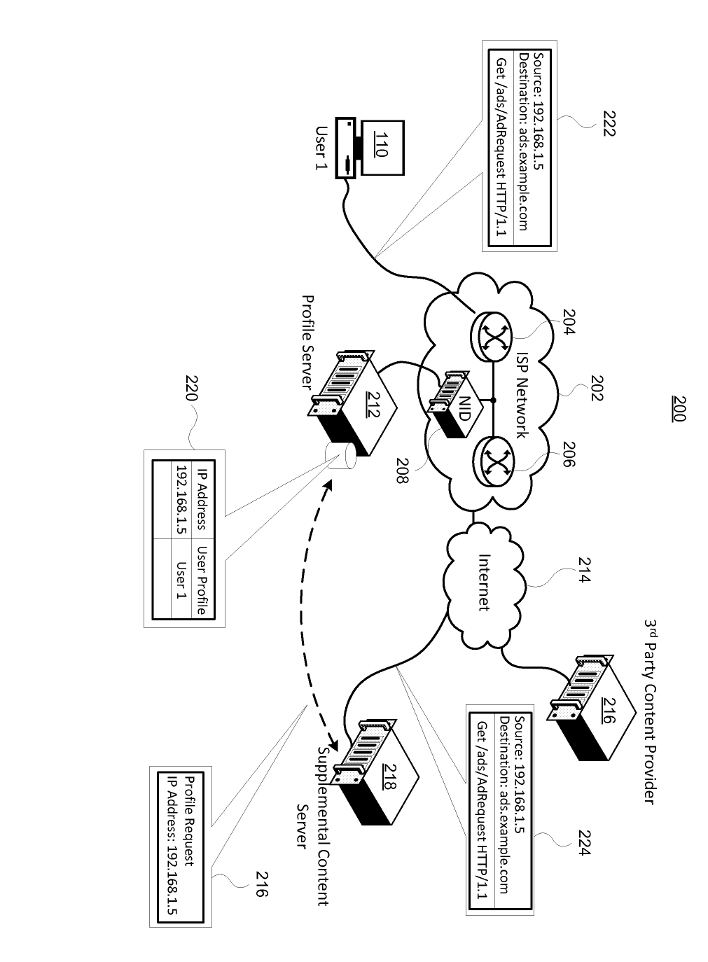

FIG. 2 depicts a system for providing tailored content to a networked device. The system 200 comprises an internet service provider (ISP) network 202. The ISP network 202 comprises a plurality of network appliances 204, 206 that connect the ISP network to other networks or devices. The ISP network 202 further comprises a network interface device (NID) 208 that monitors network traffic on the ISP network 202. The network traffic may comprise Transmission Control Protocol (TCP) and Internet Protocol (IP) traffic from a user device 110, such as hypertext transfer protocol (HTTP) traffic, which may be a computer of a subscriber of the ISP network 202, such as requests for content such as web pages as well as supplementary content such as advertisements. The NID 208 is coupled to a profile server 212. The NID 208 communicates the monitored network traffic to the profile server 212, which generates or updates a profile associated with the user device 110, or a user of the user device 210. The profiles may provide an indication as to user preferences or interests based upon the monitored traffic, and can be used to tailor content to the user's preferences. Although the profile server 212 is shown as distinct from 208, the functions provided by the profile server 212 may be integrated in or distributed amongst various components of the ISP network 202, for example the NID 208 and profile server 212 functionality may be provided within the same device or provided by an aggregate of devices distributed throughout the ISP network 202. In addition, some functions of the profile server 212 in generating and managing a user profile may be provided by resources outside of the ISP network 202.

The ISP network 202 is also coupled to one or more other networks, depicted as the Internet 214. A 3rd party content provider server 216 may be coupled to the Internet as well as a supplementary content server 218. The 3rd party content provider 216 may be a web server that returns requested web page content to the user device 110. The supplementary content server 218 may be an ad server that returns advertisements to the user device 110 for display with the requested content. In the following description of FIG. 2, the 3rd party content provider server 216 is considered to be a web page server, and the supplementary content server 218 is considered to be an advertisement server.

As will be appreciated, a user of the user device 110 may request a particular web page. The request will be routed from the user device 110, through the ISP network 202 to the 3rd party content provider server 216. The content provider server 216 returns the requested web page content back to the user device 110. The content returned may include an ad tag or other indication of an advertisement to be retrieved, which causes an advertisement to be requested from the supplementary content server 218. Similar to the web page request, the ad request is routed from the user device 110 to the supplementary content server 218 over the ISP network 202. The NID 208 monitors the traffic of the ISP network 202. As such, the NID can capture the web page requests, as well as the ad requests, sent from the user device 110 and communicate the information to the profile server 212. Although described as capturing requests, the NID may additionally or alternatively monitor the traffic sent to the user device and communicate the information to the profile server 212. Additionally or alternatively still the NID can capture request/response pairs and communicate the information to the profile server 212.

The profile server 212 may receive information about what web pages the user device 110 has requested, such as a universal resource locator (URL), and may generate or update a profile associated with the user device 110 or a user of the user device determined from the monitored traffic. For example, a profile may be associated with the network address of the user device. The profile server 212 stores the profiles and associated network addresses in a database or similar structure 220. The profile server 212 may receive an indication of a requested web page by the user device and determine information about the requested web page, such as a category or type of content of the web page that can be used to generate or update the profile associated with the network address of the user device 110.

When the user device 110 receives a requested web page, the web page may include an advertisement tag or other means for specifying an advertisement to display. As a simple example, the advertisement tag may by an <IMG> tag that indicates an advertisement image to retrieve and display as described above with reference to FIG. 1. The ad tag may indicate the supplementary content server to retrieve the advertisement from, as well as additional information such as the size and location of the ad to be displayed. The user device 110 sends an ad request 222 to the supplementary content server 218. As depicted in FIG. 2, the ad request may comprise a hyper text transport protocol (HTTP) GET request. As will be appreciated, the HTTP request may be transported in a Transport Control Protocol (TCP) message. The TCP message includes a source network address from which the TCP message is sent as well as a destination address indicating the destination of the TCP message. The destination address may be an IP address or may be a Universal Resource Locator (URL) that can be resolved to an IP address. As depicted in FIG. 2, the user device 110 has a network address of 192.168.1.5. It is noted that the network address depicted is from an unlicensed, or private, range of network addresses; however, it is contemplated that in the embodiment of FIG. 2, the IP address of the user device 110 could be a publicly available IP address assigned by the ISP to the user device 110.

The ad request 222 is routed from the user device 110 to the supplementary content server 218, which has a URL of ‘ads.example.com’. The request is received 224 at the supplementary content server 218. As depicted, the ad request sent from the user device 110 and the ad request received at the supplementary content server 218 have the same source address that is the network address has not been NATed during the routing. The supplementary content server 218 receives the ad request and determines the source network address of the user device 110 that sent the request, and uses the source network address to request 216 a profile from the profile server 212. In particular, the supplementary content server 218 requests the profile associated with the network address that the ad request was received from. The profile server 212 receives the profile request 216 and determines the profile 220 associated with the network address and returns the profile to the ad server The supplementary content server 218 receives the profile associated with the network address that requested the ad. The supplementary content server 218 may then retrieve or generate an advertisement based on the retrieved profile and returns the advertisement to the user device, which may then display the advertisement with the web page.

From the above, it should be appreciated that tailored supplemental content may be displayed with requested content by determining a profile associated with a network address of the user device and then generating or retrieving the tailored supplemental content based on the profile. The profile is generated from monitored traffic from the user device and associated with the network address of the user device. The embodiment of FIG. 2 works well if the network address within the ISP network is the same as the network address at the ad server. That is, it will work well if the network address assigned to the user device is a routable public address, so that the source address associated with messages sent from the device will be the same as the messages are routed over the ISP network and the public Internet. If there is no NAT between the ISP network and the ad server, the ISP network can associate a profile generated from the monitored traffic with the network address, and the ad server can use the same network address, which will be provided as the source address of the ad request to retrieve the associated profile and generate the tailored supplemental content. FIG. 2 is not well suited for generating tailored content if there is a NAT device between the ISP network and the ad server, such that traffic sent from the user device is associated with a first network address within the ISP network where the traffic is monitored, and a second different network address at the supplementary content server 218. That is, the profile server may generate a profile for a user device based on the traffic monitored from the user device. For example, the traffic from the user device may be associated with a private address within the ISP network, and with a different public address outside of the ISP network. The profile may be associated with the first network address for the user device within the ISP network. If the traffic from the user device is NATed between the ISP network and the ad server, the ad server will attempt to retrieve a profile associated with the user device, but will not have the network address that the profile is associated with. It is possible for the ISP network to provide the information required to resolve the NAT addresses to the supplementary content server, however this is an undesirable solution.

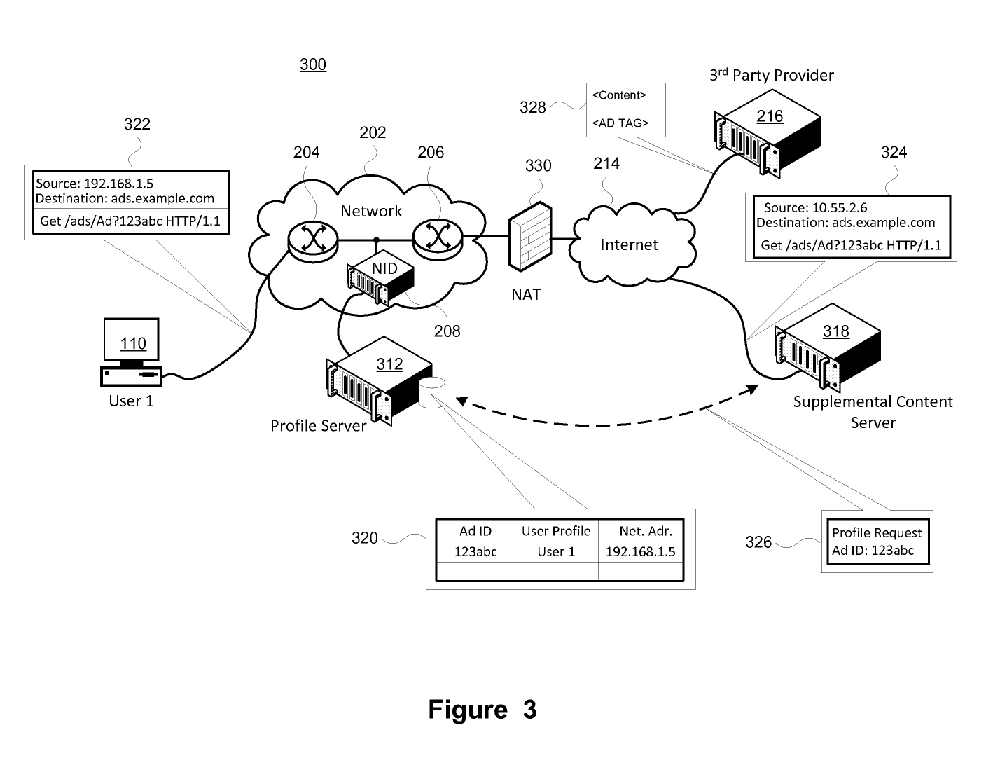

FIG. 3 depicts a system for providing tailored content to a device in NAT environment. The system 300 is similar to the system 100 described above; however, there is a NAT device 330 located between the ISP network 202 and the supplementary content server 318. As such, traffic from the user device 110 will have a source network address from a first address space, such as a private IP address, within the ISP network, but will have a different network address from a second address space, such as a public IP address, as a result of the NAT device 330 when the traffic arrives at the supplemental content server 318. As described further below, rather than associating a profile with the network address for the user device, the profile server 312 associates the profile with a unique supplemental content identifier. The supplemental content server 318 may use this unique supplemental content ID to retrieve the profile associated with the user device, regardless of whether the network address has been NATed or not.

The user device 110 can request content from various content providers. As the requests are routed from the user device 110 to the respective content providers, the traffic is routed over the ISP network 202, where the NID 208 monitors the traffic. The NID 208 may pass the monitored traffic to a profile server 312 that generates a profile based on the requested pages or content. The profiles may be generated based on a categorization of the requested page or content. The profiles provide an indication of preferences or interests of the user. The profiles may be associated with a network address associated with the user device so that subsequent traffic from the user device may be used to update the associated profile. The traffic routed from the user device 110 over the ISP network 202 may pass through a NAT device 330, which modifies the TCP messages to change a source network address from one address space, such as a private network address space, to another address space, such as a public network address space. As will be appreciated, a public network address may be used to route traffic across different interconnected networks such as the Internet 214, while a private network address may be used to route traffic within a network.

As described above, the profile server 312 generates a profile of a user device, or a user of the user device based on monitored traffic from the user device. The generated profiles may be used to tailor supplemental content to be provided to a user device. When user device requests content, the profile of the user may be retrieved and supplemental content generated and returned to the user device. However, since the network address received at the supplemental content server differs from the network address within the ISP network where the traffic is monitored for generating the profile, the supplemental content server cannot use the network address to retrieve the profile of the user device as described above with reference to FIG. 1.

Turning to providing tailored content in a NAT environment, the user device 110 requests content from a 3rd party content provider 216. The request may be an HTTP GET request or other type of content request. The 3rd party content server receives the request and returns the content 328 to the user device. As depicted, the requested content includes content as well as a supplemental content tag. The supplemental content tag may comprise scripted instructions such as Java Script and an indication of where the supplemental content is to be retrieved from. When the content is received at the user device, the scripted instructions are executed which cause a unique supplemental content identifier to be generated. The generated supplemental content identifier is then used in requesting the supplemental content from the supplemental content server 318. The scripted instructions may generate the unique ID ‘123abc’, which is then used in requesting the supplemental content. As depicted, the supplemental content may be requested through an HTTP GET request 322 that includes the generated unique ID in the requested URL string. The supplemental content request, including the unique ID, is routed to the supplemental content server 318 over the ISP network 202. As the request passes through the ISP network, the NID 208 monitors the traffic and passes the traffic to the profile server 312. The profile server 312 receives the traffic and retrieves the profile 320 of the user device 110 associated with the network address of the request. It is noted that the profile 320 can be retrieved using the network address since it is the network address of the traffic within the ISP network, and as such is the same network address associated with the profile. The profile server 312 associates the unique supplemental content ID from the monitored traffic with the profile. It is noted that the NID 208 may copy the traffic passing over the ISP network, allowing the traffic to be routed uninterrupted to the destination.

The request is routed to the supplemental content server 318 through a NAT device 330. The NAT device 330 modifies the source network address of the request from the network address used in the ISP network 202 to another network address. The modified request is routed to the supplemental content server 318 over the Internet 214. The supplemental content request 324 is received at the supplemental content server 318. As depicted, the source address differs from the source address of the request as it travelled over the ISP network; however, the request includes the unique supplemental content ID. The supplemental content server 318 uses the unique supplemental content ID to request the profile 326 from the profile server 312. The profile server 312 receives the request, retrieves the profile 320 associated with the unique content ID through the monitored traffic, and returns the profile to the supplemental content server 318. The supplemental content server 318 receives the profile 320 and generates or retrieves supplemental content tailored to the user device based on the retrieved profile, and returns the supplemental content to the user device.

As described above, a unique content ID is included in the request for the supplemental content. The unique ID is captured in the monitored traffic within the ISP network and associated with the profile of the user device. The unique ID may then be used by the supplemental content server in retrieving the profile, allowing tailored supplemental content to be provided to a user device even in a NAT environment.

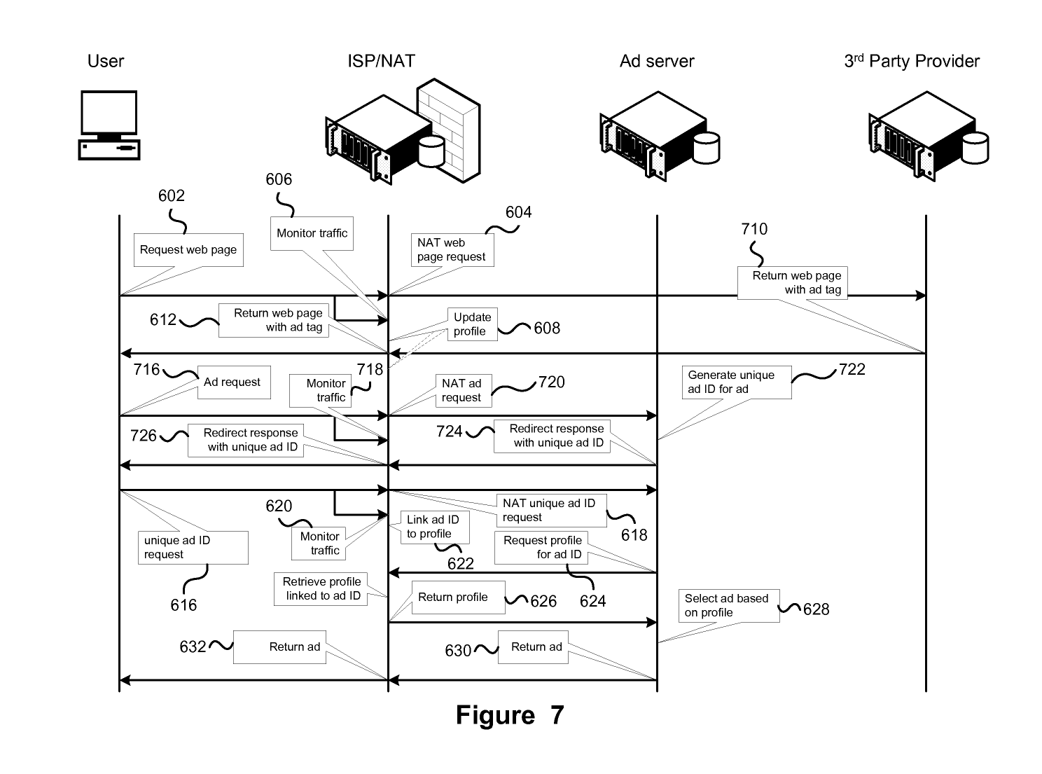

As described above, the supplemental content tag returned with the requested content may include scripted instructions for generating the unique supplemental ID. It is contemplated that the unique ID could be generated in other ways. For example, as described further with reference to FIG. 7, the supplemental content tag may comprise a request to the supplemental server, which generates the unique supplemental content ID, and returns the supplemental content request as a redirect address, including the generated supplemental ID, to the user device.

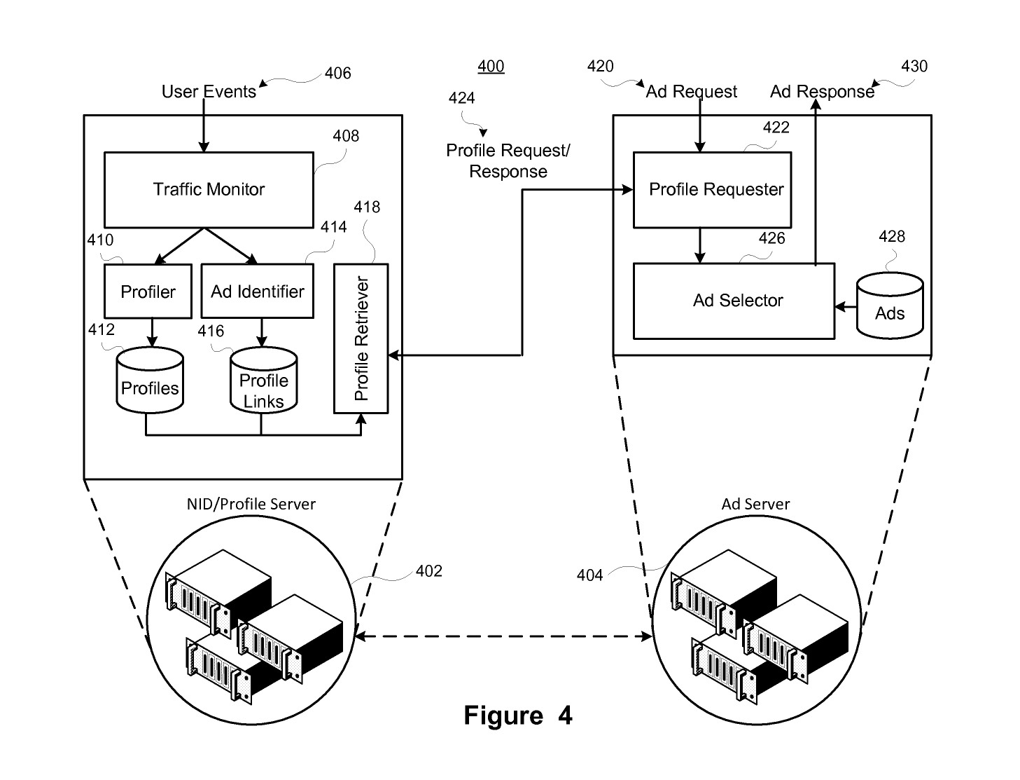

FIG. 4 depicts components of a system for providing tailored content to a device in a NAT environment. The system 400 comprises a NID/Profile server component 402 and a supplemental content server component 404. The NID/Profile server component 402 provides various functionality, including receiving user events 406. The received user events 406 comprises, for example, requests from a user device, including requests for content as well as requests for supplemental content. The user events are received at a traffic monitor component 408 that determines the type of user event and processes it accordingly. For example, if the user event is a request for content, the event is passed to a profiler component 410 that generates or updates a profile from the event. The profile component 410 may retrieve categorization information associated with the requested content and may then generate a profile based on the categorization information. Alternatively, if a profile already exists for the user device, the categorization information may be used to update the existing profile. The profile component 410 retrieves and stores the profiles in a database component 412.

The user events received at the traffic monitor component 408 may identify the user event as a request for supplemental content. User events 406 identified as a request for supplemental content may be passed to a supplemental content identifier component 414. The supplemental content identifier component 414 identifies the unique supplemental content ID from the user event 406 and links the profile associated with the user device with the supplemental content ID. The link between the unique supplemental content ID and the profile is depicted as being stored in a separate profile link database component 416; however, it is contemplated that the link may be stored in the profile database component 412.

The NID/Profile server component 402 further comprises a profile retrieval component 418 for receiving profile requests, retrieving a profile associated with a unique supplemental content ID received in the profile request, and returning the profile.

The supplemental content server component 404 includes functionality for receiving requests for supplemental content 420. The supplemental content requests 420 include a unique supplemental content ID, which is used by a profile requester component 422 for sending a profile request 424 to the profile retrieval component 418 and receiving the returned profile. The profile may then be used by a supplemental content selector component 426. The supplemental content selector component 426 is depicted as retrieving supplemental content from a supplemental content database component 428; however it is contemplated that the profile could be used to generate the supplemental content based on the profile. Once the supplemental content has been selected or generated based on the profile, the supplemental content selector component 426 may than return the supplemental content 430 to the user device.

Although depicted as being a single component, the functionality provided by NID/Profile server component 402 may be provided by a plurality of physical devices, each of which may include a processor or processors for executing instruction and a memory for storing instructions that when executed by the processor or processors configure the devices to provide at least a portion of the functionality described. For example, a plurality of NID devices may be included in various different locations within the ISP network so that all, or a majority, of the network traffic of the ISP network may be monitored by a NID. Similarly, the functionality of the profile server, as well as the functionality of the supplemental content server, may be provided by a plurality of physical servers.

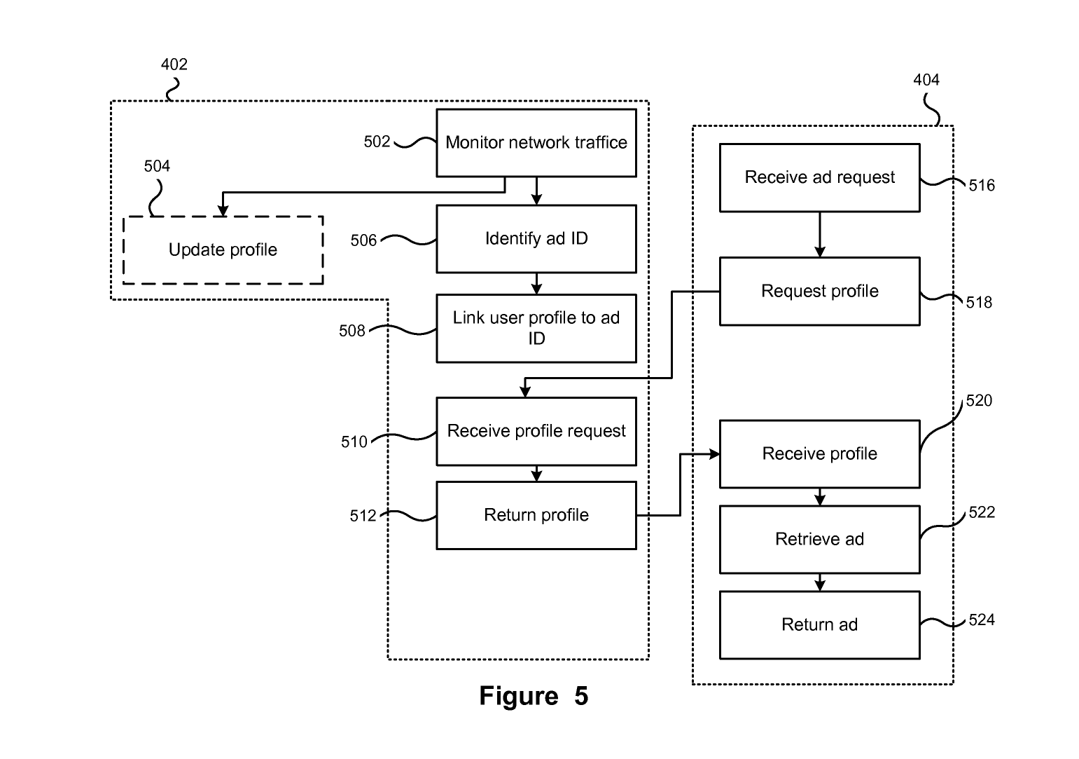

FIG. 5 depicts a method of providing tailored content to a device in a NAT environment. Portions of the depicted method may be performed at various components, such as the NID/Profile server 402 or the supplemental content server 404 described above. The method 500 begins with monitoring network traffic (502) on a network. The network may be an ISP network. The monitored traffic may be associated with a network address from a private network address range. The monitored traffic may comprise an identification of the content requested by a user device. The method may use the monitored traffic to update a profile (504) associated with the user device. If the monitored traffic is a request for supplemental content, which includes a unique supplemental content ID, the method identifies the unique supplemental content ID (506). The unique supplemental content ID is then linked to the profile (508) associated with the user device.

As described above, the monitoring of the network traffic may copy the network traffic and as such, does not interrupt the routing of the requests. As such, when the monitored network traffic is a request for supplemental content, the request will be received at a supplemental content server, which receives the request (516). The supplemental content requests includes a unique supplemental content ID, which would have been identified in the monitored network traffic and associated with the profile of the user device. The unique supplemental ID is used to request a profile (518). The profile request, which includes the unique supplemental ID, is received (510) and the profile associated with the unique supplemental content ID is retrieved and returned (512). The returned profile is received (520) and used to retrieve, or generate, supplemental content (522) that is tailored to the preferences or interests of the user of the user device. Once the supplemental content is retrieved or generated, it can be returned (524) to the user device.

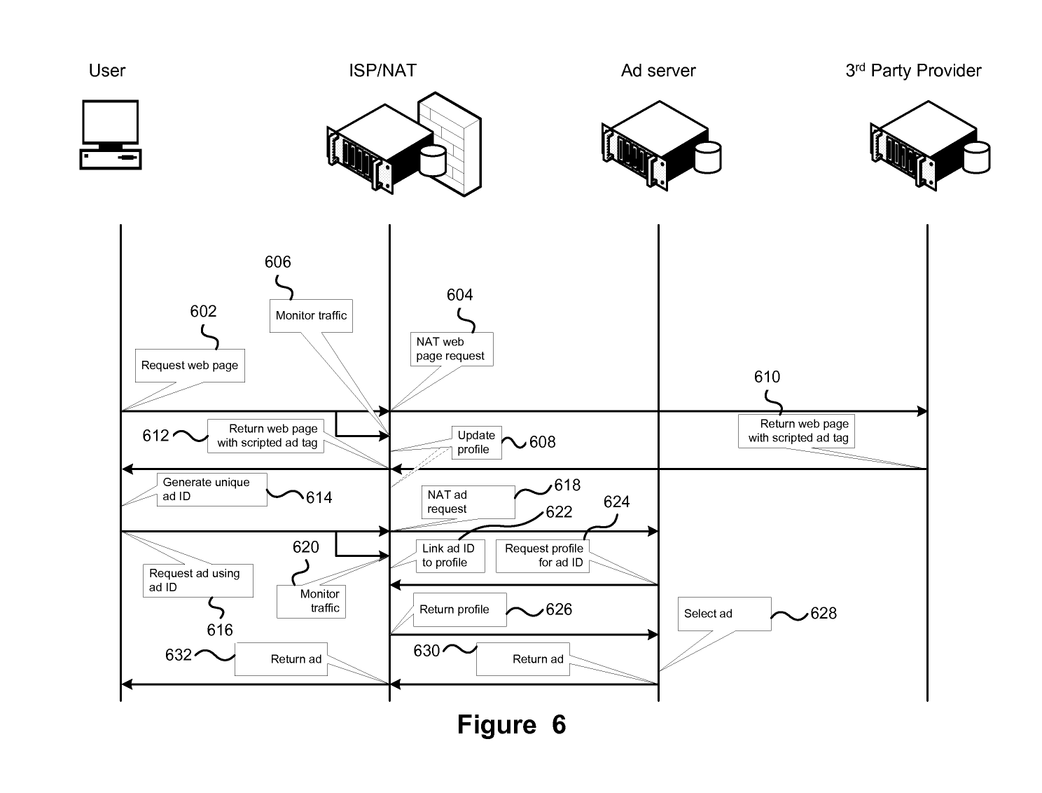

FIG. 6 depicts a process flow for providing tailored content to a device in a NAT environment. In the process depicted in FIG. 6, it is assumed that a profile already exists for the user device 110. As described above, the profile can be generated based on monitored traffic from the user device 110. The process is described with regards to providing supplemental content for display with a requested web page; however, it is contemplated that the process could be used to provide tailored supplemental content other than an advertisement. Further, it is contemplated that the supplemental content could be could be displayed with content other than a web page.

The user device 110 requests a web page (602). The request includes a source network address associated with the user device 110. The request is routed to a 3rd party provider 318, which in this example would be a web server. As the request is routed to the 3rd party provider 318 it travels over the ISP network, where the source network address of the request is NATed by the NAT device and routed to the 3rd party provider. Prior to NATing the source network address of the request, the ISP network monitors the traffic (606), which may include copying the traffic and passing it to a profile server to update the profile (608) associated with the user device 110. FIG. 6 depicts monitoring traffic that is traversing the network from the user device for simplicity of the Figure. It is contemplated that network traffic traversing the network to the user device may also be monitored. Similarly, although FIG. 6 depicts updating the profile when a request is monitored, it is possible to update the profile based on the monitored traffic sent to the user device, for example the web page or data returned in response to the request, as depicted by the dashed line of 608. Alternatively, the profile may be updated based on monitored traffic that comprises a request/response pair, that is, the profile may be updated based on data returned to a user device in response to a request. The profile may be updated by determining one or more categories or characteristics of the requested web page, or other monitored traffic, and modifying the profile to reflect the user's assumed interest in the categories or characteristics. The NATed request is received at the 3rd party provider, which returns the requested web page (610). The returned web page includes one or more supplemental content tags that indicate where to retrieve supplemental content from. The supplemental content tag is a scripted supplemental content tag that includes instructions for execution at the user device that generate a unique supplemental content identifier. The returned web page is routed back to the user device through the NAT device so that the NATed address of the user device can be returned to the network address of the user device 110 and the web page can be routed to the user device (612).

The user device 110 receives the web page and executes the scripted instructions of the supplemental content tag in order to generate a unique supplemental content ID (614) and sends a supplemental content request to the supplemental content server using the generated supplemental content ID (616). Similar to the web page request, the supplemental content request is routed to its destination over the ISP network, where it is NATed (618) to change the source address from a first network address used within the ISP network, to a second network address used in the publicly accessible networks. Prior to NATing the supplemental content request, the ISP network monitors the network traffic (620), which may include copying the traffic and forwarding the supplemental content request to a profile server. The supplemental content request is processed to identify the unique supplemental content ID included in the supplemental content request. The profile associated with the user device, for example by the network address of the user device within the ISP network, is linked to the unique supplemental content ID (622) from the supplemental content request.

The supplemental content request is received at the supplemental content server and the unique supplemental content ID is extracted and used for requesting a profile (624) from the profile server. The profile server receives the profile request that includes the unique supplemental content ID and returns the profile that has been associated with the unique supplemental content ID (626). The supplemental content server receives the profile and selects supplemental content (628) tailored to the user based on the inferred interests or preferences provided by the profile. The supplemental content is returned (630) to the user device 110. The supplemental content may be routed through the NAT device, where the network address is modified to the network address associated with the user device within the ISP network. The ISP network returns the supplemental content to the user device (632) where it can be displayed with the requested web page.

FIG. 7 depicts a further process flow for providing tailored content to a device in a NAT environment. The overall process is similar to that described above with reference to FIG. 6, and as such, similar portions of the process are not described again in detail. In the process of FIG. 6, the user device executes scripted instructions for generating a unique supplemental content ID used in requesting the ad. However, some user devices may not be configured to execute the scripted instructions. The process of FIG. 7 allows the unique supplemental content ID to be generated at the supplemental content server and returned to the user device, which then proceeds to request the supplemental content using the returned unique supplemental content ID as described above.

As depicted, the user device 110 requests a web page (602) which is received at the 3rd party provider. The profile associated with the user or user device may be generated or updated based on monitored network traffic from the user device, or alternatively or additionally, the profile may be generated or updated based on monitored network traffic to the user device, or pairs or request/responses as described above. The 3rd party provider returns the requested web page with the supplemental content tag (710); however the supplemental content tag points to a location on the supplemental content server that will generate return a unique supplemental content ID. The user device receives the web page and requests the supplemental content (716), without a unique supplemental content ID, the supplemental content request is monitored by the ISP network (718), however the supplemental content request does not include a unique supplemental content ID and so no profile can be linked. The supplemental content request is NATed and routed to the supplemental content server (720). The supplemental content server receives the supplemental content request and generates a unique supplemental content ID (722) and responds to the supplemental content request with a redirect response, which may be for example an HTTP 3xx response and in particular an HTTP 303 response. The redirect response provides an indication of where to request the supplemental content from and includes the generated unique supplemental content ID. The redirect response is routed back to the user device (724) through the NAT device (726). The browser receives the redirect response, which causes the user device to request the supplemental content from the specified location, which includes the unique supplemental content ID. The user device requests the supplemental content using the unique ID (616) and the process proceeds in the same manner as described above with reference to FIG. 6.

The above has described providing tailored supplemental content to a user device, even in a NAT environment, which makes linking a profile to a user device through the network address difficult. A profile can be retrieved for a user device through the use of unique supplemental content ID when requesting supplemental content such as an advertisement. The ISP network monitors the traffic to identify the unique supplemental content ID and associate the unique supplemental content ID with the profile of the user or user device. As such, the supplemental content server can utilize the unique supplemental content ID to retrieve the profile associated with the user or user device requesting an ad, and as such can tailor the supplemental content based on the profile. It is contemplated that a requested content, such as a web page may include a plurality of supplemental content portions, such as ads, which each may be provided as described above. However it is contemplated that each individual supplemental content requests in a common content may utilize the same unique supplemental content ID, that is the unique supplemental content ID does not need to uniquely identify each requested supplemental content, but rather should be able to uniquely identify a user or user device in order to allow the profile of the user or user device to be retrieved using the unique supplemental content ID. Further, the unique supplemental content ID need only be unique over a relatively short period of time, as the profile request for the profile will arrive at the profile server shortly after the supplemental content request is monitored on the ISP network. The unique supplemental content ID can be generated, either at the user device, or at a server, by generating a long random string. Although in theory, the same random string could be generated for different supplemental content, the lifetime of the unique supplemental identifier may be relatively short, since the profile server will associate the profile with the unique supplemental identifier when the user device requests the supplemental content. The supplemental content provider will subsequently request the profile associated with the unique supplemental content ID. As such, the unique supplemental content IDs need only be unique over a short period of time, such as a few seconds. As such, the chances of two identical long random strings being generated in the same short period of time are extremely small.

The above has referred to a unique supplemental content ID for the clarity of description, it should be appreciated that the unique ID does not need to be specific to an ad. An identifier within a content request that is monitored by a first network and linked to a profile of the requesting device may be used to tailor content, which may include supplemental content for display with other requested content, to the user or user device even in a NAT environment. Although the embodiments have been described with regards to tailoring ads for display on web pages, it is contemplated that the tailoring process in a NAT environment can be applied to other content. For example, rather than a web page, the ads could be displayed in an application, audio or video, or other types of content. Further, the tailored content does not need to be an ad, rather the tailored content could be suggested content that the user or user device may be interested in, as may be inferred from the profile.

As described above, it is possible to tailor content even in a NAT environment. Although a limited number of illustrative applications were described, it will be appreciated that the tailoring of content may be used in a wide range of applications. In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media.

As another example, transitory computer readable media can include signals in air, wires, conductors, optical fibers, circuits, and any suitable media that is fleeting and devoid of any semblance of permanence during transmission, and/or any suitable intangible media.

Although the description discloses example methods, system and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

What is claimed is:

1. A method for providing tailored supplemental content to a user, the method comprising:
receiving, at a server, a supplemental content identifier (ID) identified from monitored network traffic from a user device traversing a first network, the network traffic from the user device associated with a first network address while traversing the first network which is translated to a second network address while traversing a second network;
linking, at the server, a profile associated with the first network address to the identified supplemental content ID;
receiving, at the server, a profile request from a supplemental content provider, the profile request comprising the supplemental content ID; and
sending, from the server to the supplemental content provider, the profile linked to the supplemental content ID.

2. The method of claim 1, wherein the monitored traffic, from which the supplemental content ID is identified, comprises a supplemental content request sent from the user device to the supplemental content provider.

3. The method of claim 1, wherein the traffic from the user device is modified by a network address translation (NAT) device between the first network and the second network.

4. The method of claim 1, wherein the first network is an Internet Service Provider (ISP) network and the second network is a publicly accessible network.

5. The method of claim 1, further comprising:
receiving user-requested content at the user device, the user-requested content including instructions for generating the supplemental content ID at the user device;
executing, at the device, the instructions for generating the supplemental content ID; and
sending, from the device to the supplemental content provider, a supplemental content request including the supplemental content ID.

6. The method of claim 5, further comprising:
receiving at the supplemental content provider the supplemental content request including the supplemental content ID; and
sending, from the supplemental content provider to the server, the profile request including the supplemental content ID from the supplemental content request.

7. The method of claim 6, further comprising:
receiving, at the supplemental content provider, the profile linked to the supplemental content ID;
retrieving, at the supplemental content provider, supplemental content based on the received profile; and
sending the retrieved supplemental content from the supplemental content provider to the user device.

8. The method of claim 1, further comprising:
receiving user-requested content at the user device, the user-requested content including a request for content from the supplemental content provider;
requesting, from the supplemental content provider, the supplemental content;
receiving, at the supplemental content provider, the request for the supplemental content;
generating, at the supplemental content provider, the supplemental content ID; and
returning, from the supplemental content provider to the user device, the generated supplemental content ID in a redirection response.

9. The method of claim 8, further comprising:
receiving the redirection response at the user device;
redirecting the request for the supplemental content to a location specified by the redirection response, the location specified comprising the generated supplemental content ID;
receiving the redirected request for the content including the generated supplemental content ID at supplemental content provider; and
sending, from the supplemental content provider to the server, the profile request including the supplemental content ID from the redirected request for the content.

10. The method of claim 8, further comprising:
receiving, at the supplemental content provider, the profile linked to the supplemental content ID;
retrieving, at the supplemental content provider, supplemental content based on the received profile; and
sending the retrieved supplemental content from the supplemental content provider to the user device.

11. The method of claim 1, further comprising:
updating, at the server, the profile associated with the first network address based on the monitored network traffic.

12. The method of claim 11, wherein the profile provides one or more of:
a categorization of inferred interests;
a group associated with information for use in tailoring content; and
demographic information.

13. The method of claim 1, wherein the monitored network traffic includes user-requested content requested from the user device, wherein the supplemental content ID is located within an advertisement tag in the supplemental content.

14. A device for providing a profile for use in providing tailored supplemental content to a user, the device comprising:
an network interface for transmitting and receiving data over a network;
a processor for executing instructions; and
a memory storing instructions, the instructions when executed by the processor, configuring the device to provide a method comprising:
receiving, over the network interface, a supplemental content identifier (ID) identified from monitored network traffic from a user device traversing a first network, the network traffic from the user device associated with a first network address while traversing the first network which is translated to a second network address while traversing a second network;
linking a profile associated with the first network address to the identified supplemental content ID;
receiving, over the network interface, a profile request from a supplemental content provider, the profile request comprising the supplemental content ID; and
sending, over the network interface, to the supplemental content provider, the profile linked to the supplemental content ID.

15. The device of claim 14, wherein the method provided by the executed instructions further comprises:
updating the profile associated with the first network address based on the monitored network traffic.

16. The device of claim 15, wherein the profile provides one or more of:
a categorization of inferred interests;
a group associated with information for use in tailoring content; and
demographic information.

17. A system for providing tailored supplemental content to a user, the system comprising:
a network interface device (NID) adapted for monitoring traffic in a first network;
a server adapted for:
receiving from the NID a supplemental content identifier (ID) identified from the monitored network traffic from a user device traversing the first network, the network traffic from the user device associated with a first network address while traversing the first network which is translated to a second network address while traversing a second network the server;
linking a profile associated with the first network address to the identified supplemental content ID;
receiving a profile request from a supplemental content provider, the profile request comprising the supplemental content ID; and
sending to the supplemental content provider, the profile linked to the supplemental content ID; and
a supplemental content provider server adapted for:
receiving a supplemental content request including the supplemental content ID;
sending the profile request including the supplemental content ID from the supplemental content request;
receiving, at the supplemental content provider, the profile linked to the supplemental content ID;
retrieving, at the supplemental content provider, supplemental content based on the received profile; and
sending the retrieved supplemental content from the supplemental content provider to the user device.

18. The system of claim 17, wherein the monitored traffic from which the supplemental content ID is identified comprises a supplemental content request sent from the user device to the supplemental content provider.

19. The system of claim 17, wherein the traffic from the user device is modified by a network address translation (NAT) device between the first network and the second network.

20. The system of claim 17, wherein the first network is an Internet Service Provider (ISP) network and the second network is a publicly accessible network.

21. The system of claim 17, further comprising:
a user device adapted for:
receiving user-requested content including instructions for generating the supplemental content ID at the user device;
executing, at the device, the instructions for generating the supplemental content ID; and
sending, from the device to the supplemental content provider, a supplemental content request including the supplemental content ID.

22. The system of claim 17, further comprising:
a user device adapted for:
receiving user-requested content including a request for content from the supplemental content provider; and
requesting, from the supplemental content provider server, the supplemental content,
wherein the supplemental content provider server is further adapted for:
receiving the request for the supplemental content;
generating the supplemental content ID; and
returning to the user device, the generated supplemental content ID in a redirection response.

23. The system of claim 22, wherein the method provided by the supplemental content provider server further comprises:
receiving a redirected request, from the user device, for the content including the generated supplemental content ID at supplemental content provider; and
sending, to the server, the profile request including the supplemental content ID from the redirected request for the content.

24. The system of claim 17, wherein the method provided by the supplemental content provider server further comprises:
receiving the profile linked to the supplemental content ID;
retrieving supplemental content based on the received profile; and
sending the retrieved supplemental content to the user device.

25. The system of claim 17, wherein the method provided by the server further comprises:
updating the profile associated with the first network address based on the monitored network traffic, wherein the profile provides a categorization of inferred interests.

26. The system of claim 17, wherein the monitored network traffic includes user-requested content requested from the user device, wherein the supplemental content ID is located within an advertisement tag in the supplemental content.

27. The system of claim 26, wherein the profile provides one or more of:
a categorization of inferred interests;
a group associated with information for use in tailoring content; and
demographic information.
